(19) United States
(12) Patent Application Publication
(10) Pub. No.: US 2003/0050829 A1
(43) Pub. Date: Mar. 13, 2003

(54) Method and system for collecting and distributing data evaluating the job performances of short term job contractors through a computer controlled centralized database

(75) Inventors: Timothy Alan Dietz, Austin, TX (US); Walid Kobrosly, Round Rock, TX (US); Nadeem Malik, Austin, TX (US)

Correspondence Address: Mark E. McBurney, International Business Machines Corporation, Intel Prop Law Dept., Internal Zip 4054, 11400 Burnet Road, Austin, TX, 78758, US

(73) Assignee: International Business Machines Corporation, Armonk, NY

(21) Appl. No.: 09/951,984

(22) Filed: Sep. 13, 2001

(51) Int. Cl. G06F 17/60

(52) U.S. Cl. 705/11

(57) ABSTRACT

A method of database management for distributing data relative to the job performances of short term job contractors comprising soliciting through an interactive computer display interface, job performance evaluations from each of a plurality of employers for each of a plurality of short term job contractors and storing such job performance evaluations. The method and system then interpret the job performance evaluations for each of the job contractors and permit each of said employers to obtain an interpreted job performance evaluation for each of said job contractors. The step of interpreting the evaluation by the third party database manager combines the job performance evaluations from a plurality of said employers for each of said job contractors. In such a case, the individual employers' evaluations are further safeguarded by being integrated with the evaluations of several other businesses. The resulting evaluations are preferably numerical. Such numerical evaluations would preferably include the average weighted numerical evaluations of said plurality of employers.

### TECHNICAL FIELD

The present invention relates to a method and system for doing business using computer controlled centralized databases for the collection and distribution of data relative to job performances, and particularly the performance of short term job contractors.

### BACKGROUND OF RELATED ART

Over the past decade, businesses have been undergoing major changes in the ways that they conduct their business. One of the most dramatic trends has been in the reduction of employees, functions and facilities through the out-sourcing of virtually anything that can be out-sourced. This has made many businesses leaner and more competitive with significantly reduced staffs and facilities to be maintained. However, along with these advantages has come a loss in control of the performance of many functions, as well as a diminished ability to control the product quality of the resulting products. In attempts at being cost effective, businesses have tried to optimize the hiring of workers and contractors, usually for short terms, as needed, to provide products and services. This has resulted in an army of short term job contractors who move from job to job providing, on a short term basis, skilled manpower as needed for the production of relatively short runs of components for the business' overall products.

In this type of an environment, the businesses employing such short term contractors are finding it hard to maintain quality. Even if a business finds a particular job contractor to be effective, the job person or small contractor may not be available the next time the hiring business needs help and support. Very little organized information is available to employing businesses, except, perhaps, a few worn personal letters of recommendation. Employers have traditionally been reluctant to share opinions about employees because of the fear of litigation for their opinions. In the present environment with short term job contractors, even less information is available on which an employer for whom they have performed a job contract may provide a recommendation. Thus, there is an even further reluctance to provide business-to-business job contractor performance evaluations.

Short term job contractors often find themselves in similar predicaments to the employers. Such job contractors may have worked very effectively over a course of years for dozens of employers. Yet such employees may have a hard time getting the advantageous contracts that they may deserve, particularly from new employers because they cannot establish an effective work record due to the reluctance of past employers to provide recommendations.

### SUMMARY OF THE PRESENT INVENTION

The present invention provides a solution which should satisfy the concerns of the employers in determining the effectiveness of potential short term job contractors, as well as the needs of the job contractors themselves to establish a work record of their job effectiveness.

According to its general aspects, the invention is a method of database management for distributing data relative to the job performances of short term job contractors comprising soliciting through an interactive computer display interface, job performance evaluations from each of a plurality of employers for each of a plurality of short term job contractors and storing such job performance evaluations. The method and system then interpret the job performance evaluations for each of the job contractors and permit each of said employers to obtain an interpreted job performance evaluation for each of said job contractors.

It is hoped that the employers of such short term job contractors will be much less reluctant to give such job evaluations as the evaluations are going through a third party that runs the database and interprets the evaluation so that it no longer has the direct connection or traceability to the evaluating employer. In addition, because the job contractor himself may need such employer evaluations in order to develop a resume or work record, the job contractor may be ready to forego any privacy concerns that he may have in order to establish his needed work record. In the case of businesses that may remain reluctant to share opinions about employee permission, such permission should be relatively easy to obtain because of the employee's need to establish a viable work record.

The method and system of the present invention should be relatively effective where the step of interpreting the evaluation by the third party database manager combines the job performance evaluations from a plurality of said employers for each of said job contractors. In such a case, the individual employer's evaluation would be further safeguarded by being integrated with the evaluations of several other businesses. This is particularly the case when the resulting evaluations are numerical. Such numerical evaluations would preferably include the average weighted numerical evaluations of said plurality of employers. The combined evaluations also preferably include a plurality of weighted numerical levels solicited from the employers for each of a plurality of job attributes for a selected job contractor. Furthermore, the combined evaluations include a plurality of average weighted numerical levels solicited from said plurality of employers for each of a plurality of job attributes for a selected job contractor.

Finally, the step of enabling each employer to obtain an interpreted job performance further includes the step of providing the average weighted numerical levels solicited from all of said employers in said database for each of a plurality of job attributes for all of the job contractors in the database so that an employer may compare said interpreted job performance of a selected job contractor to the average weighted levels for said job attributes for all of said job contractors.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit, a database and network connections via a communications adapter which is capable of providing the display computer managed database system for collecting and distributing data on the job performances of short term job contractors;

FIG. 2 is a diagrammatic illustration of an interactive display screen for soliciting job performance evaluations of short term job contractors from their employers;

FIG. 3 is a diagrammatic illustration of an interactive display screen for providing job performance evaluations of short term job contractors for prospective employers;

FIG. 4 is an illustrative flowchart describing the setting up of the process of the present invention for a method of database management for distributing data relative to the job performances of short term job contractors; and

FIG. 5 is a flowchart of an illustrative run of the process setup in FIG. 4.

### DETAILED DESCRIPTION OF THE PREFERRED EMBODIMENT

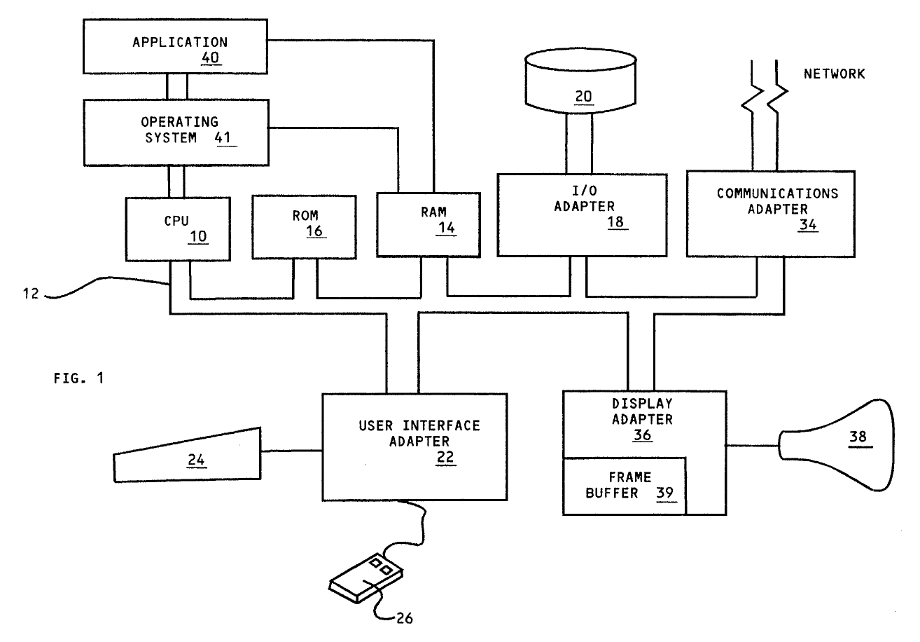

Referring to FIG. 1, a typical data processing terminal is shown which may function as the Web display station used for a method of database management for soliciting and distributing data relative to the job performances of short term job contractors.

A central processing unit (CPU) 10, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 1. Operating system 41 may be one of the commercially available operating systems such as the AIX operating system available from IBM; Microsoft's WindowsMe™ or Windows 2000™, as well as various other UNIX and Linux operating systems. Application programs 40, controlled by the system, are moved into and out of the main memory Random Access Memory (RAM) 14. These programs include the programs of the present invention for a method of database management for soliciting and distributing data relative to the job performances of short term job contractors. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20 to provide the storage of the database of the present invention. Communications adapter 34 interconnects bus 12 with an outside network enabling the data processing system to communicate with other such systems over a Local Area Network (LAN) or a Wide Area Network (WAN), which includes, of course, the Web or Internet. The latter will provide a primary communication means through which prospective employers may contact the database to obtain job evaluations of prospective job contractors, and employers may be solicited by database management to get their evaluations of short term job contractors who have done work for the employers.

I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

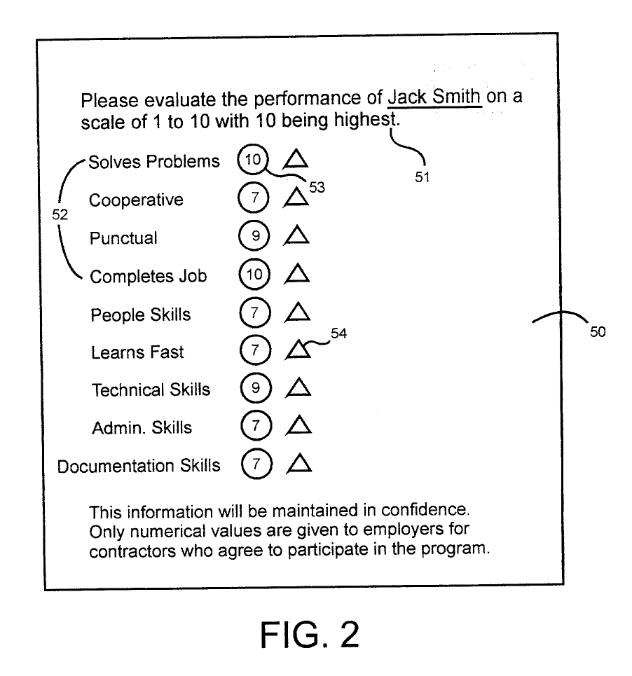

With reference to FIG. 2, an illustrative display screen for the soliciting of job evaluations for short term job contractors from their employers is shown. Let us assume a fictitious illustrative central distribution database system, “The U.S. Jobbers' Poll Bureau”, that lists businesses among its job evaluation contributors and members. The database solicits from its members, job performance evaluations for short term job contractors who may be workers or other businesses that provide components or services. In return for providing such job performance evaluations, the members may obtain from the database average or consensus job performance evaluations of the collective member inputs with respect to particular job contractors that the member is considering hiring. In order to insulate the business members providing evaluations from possible legal questions with respect to contractors offended by their input, the evaluations provided to requesting members are preferably numerical and collective, or average, for the whole set of inputs relative to a particular contractor. However, legal issues aside, the evaluations put out could contain comments of individual businesses. Also, in order to avoid any legal issues, the job contractor should preferably be requested to consent to have an evaluation of his performance distributed to other prospective employers. Most job contractors should be agreeable as it could help in securing future job contracts. Also, the knowledge that they will have their job performance evaluation widely distributed is likely to improve the contractor's job performance.

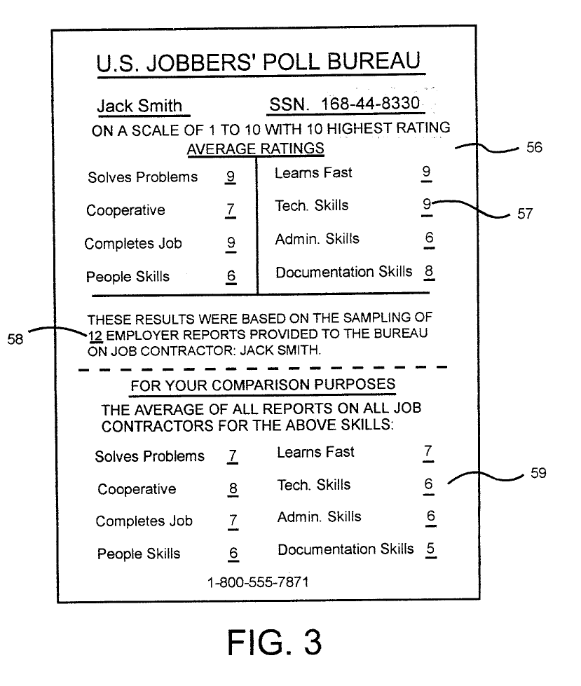

With respect to the dialog screen 50 of FIG. 2, the employer is requested to evaluate the performance of a contractor 51 in eight job attributes 52, and rate numerically on a scale of 1 to 10 in windows 53 controlled by interactive buttons 54. Actually, the database may offer many more attribute categories from which the employer may select the attribute categories most appropriate to the function or job being evaluated. For example, as will be hereinafter discussed with respect to FIG. 3, when an employer is seeking an evaluation on a particular job contractor from the database, he may also be permitted to select the attribute categories that he needs to have evaluated. Subsequently, when he evaluates the contractor, the employer should cover the same attributes.

With respect to the dialog screen 56 of FIG. 3, the employer requesting a performance evaluation report on a job contractor is provided a numerical output 57 rating the contractor in the selected categories. This output is the collective average on inputs on this contractor from a sampling 58 of twelve employer evaluation reports. As mentioned previously, the employer may select the desired attribute categories from a listing (not shown) of many of such categories. Should the employer not select attribute categories, he will be provided evaluations in a default group of attribute categories.

For comparison purposes, the requesting employer may also optionally be provided the average numerical levels 59 for all reports from all participating employers on all evaluated job contractors in the database.

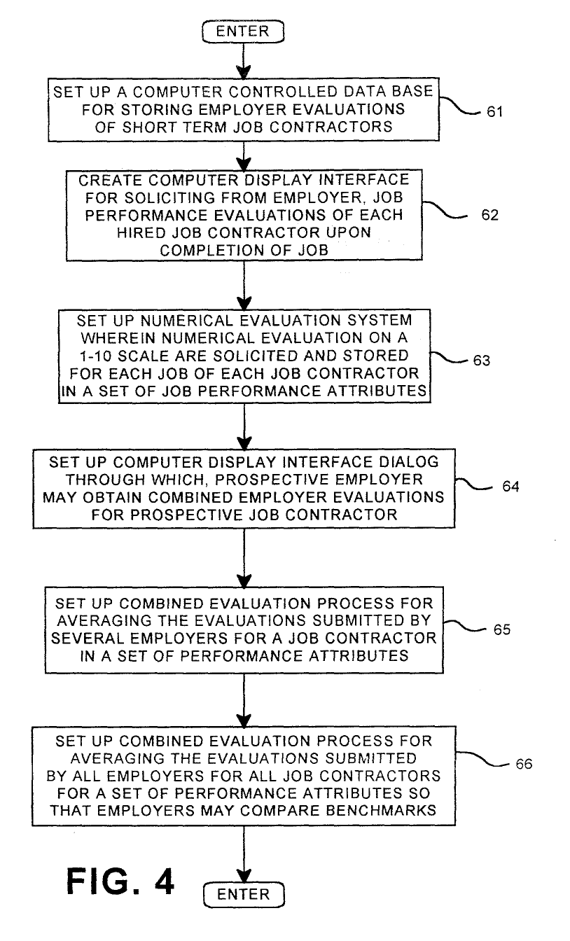

Now, with reference to FIG. 4, we will describe the setting up or development of a program according to the present invention for database management for soliciting and distributing data relative to the job performances of short term job contractors. There is set up a computer controlled database for storing evaluations of the short term job contractors, step 61. There is created a display interface for interactively soliciting from employers, job performance evaluations of each hired job contractor upon completion of each job, step 62. A numerical evaluation system is set up wherein, on a scale of 1 to 10, evaluations are solicited from these employers and stored for each job of each job contractor for a set of performance attributes, step 63. A computer display interface dialog is set up through which a prospective employer may obtain combined employer evaluations for a prospective job contractor, step 64. Then, there is set up a combined evaluation process for averaging the evaluations submitted by several employers for a given job contractor for a set of performance attributes, step 65. Finally, there is set up a combined evaluation process for averaging the evaluations submitted by all employers for all job contractors for a set of performance attributes so that employers may compare benchmarks, step 66.

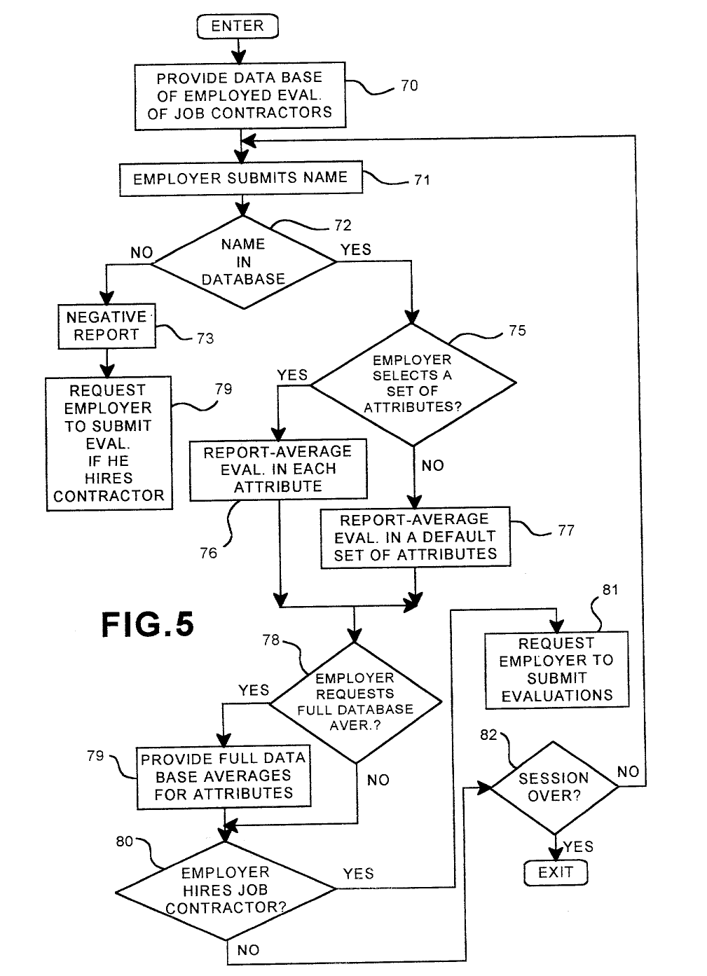

Now that the basic program set up has been described, there will be described with respect to FIG. 5 a flowchart of a simple operation showing how the program could be run. The database set up in FIG. 4 is provided, step 70. An employer submits the name of a job contractor for evaluation, step 71. A determination is made, step 72, as to whether the name is in the database. If No, the employer is so advised, step 73, and requested to submit a post job evaluation, step 74, should the employer still decide to hire the job contractor. If Yes, the job contractor is in the database, then, step 75, a determination is made as to whether the requesting employer has selected a set of attributes upon which he desires input. If No, a report is displayed to the employer giving him an average numerical evaluation in each of a default group of attributes, step 77. If Yes, a report is displayed to the employer giving him an average numerical evaluation in each of the selected group of attributes, step 76. At this point, after either step 76 or 77, a determination is made, step 78, as to whether the employer has requested a full database average evaluation for all of the attributes. If Yes, he is presented with such a comparative full average, step 79, shown as data 59 in FIG. 3. After step 79 or a No in step 78, a determination is made, step 89, as to whether the job contractor is hired. If Yes, step 81, the employer is requested to submit a post job evaluation. Next, or if there is a No from step 80, a determination may conveniently be made as to whether the session is over, step 82. If Yes, the session is exited. If No, the session is returned to step 71 where the submission of a next job contractor's name is awaited.

One of the preferred implementations of the present invention is in application program 40 made up of programming steps or instructions resident in RAM 14, FIG. 1, of a Web receiving station during various Web operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A database system for distributing data relative to the job performances of short term job contractors comprising:
means for storing job performance evaluation for each of a plurality of short term job contractors; and
a computer controlled interactive display system including:
means for soliciting said job performance evaluations from each of a plurality of employers for each of said plurality of job contractors;
means for interpreting said job performance evaluations for each of said job contractors; and
means enabling each of said employers to obtain an interpreted job performance evaluation for each of said job contractors.

2. The database system of claim 1 wherein:
said means for interpreting said job performance evaluations combine the job performance evaluations from a plurality of said employers for each of said job contractors.

3. The database system of claim 2 wherein said evaluations include weighted numerical evaluations.

4. The database system of claim 3 wherein said combined evaluations include the average weighted numerical evaluations of said plurality of employers.

5. The database system of claim 3 wherein said each of said combined evaluations include a plurality of weighted numerical levels solicited from said employers for each of a plurality of job attributes for a selected job contractor.

6. The database system of claim 5 wherein said combined evaluations includes a plurality of average weighted numerical levels solicited from said plurality of employers for each of a plurality of job attributes for a selected job contractor.

7. The database system of claim 6 wherein said means enabling each employer to obtain an interpreted job performance further includes:
means providing the average weighted numerical levels solicited from all of said employers in said database for each of a plurality of job attributes for all of the job contractors in the database,
whereby an employer may compare said interpreted job performance of a selected job contractor to the average weighted levels for said job attributes for all of said job contractors.

8. The database system of claim 6 wherein said means enabling each employer to obtain an interpreted job performance further includes:
the numerical total of said combined job performance evaluations said interpreted job performance evaluation is based upon.

9. A method of database management for distributing data relative to the job performances of short term job contractors comprising:
soliciting through an interactive computer display interface job performance evaluations from each of a plurality of employers for each of a plurality of short term job contractors;
storing said job performance evaluations;
interpreting said job performance evaluations for each of said job contractors; and
enabling each of said employers to obtain an interpreted job performance evaluation for each of said job contractors.

10. The method of claim 9 wherein:
said step of interpreting said job performance evaluations combines the job performance evaluations from a plurality of said employers for each of said job contractors.

11. The method of claim 9 wherein said evaluations include weighted numerical evaluations.

12. The method of claim 11 wherein said combined evaluations include the average weighted numerical evaluations of said plurality of employers.

13. The method of claim 11 wherein said each of said combined evaluations includes a plurality of weighted numerical levels solicited from said employers for each of a plurality of job attributes for a selected job contractor.

14. The method of claim 13 wherein said combined evaluations include a plurality of average weighted numerical levels solicited from said plurality of employers for each of a plurality of job attributes for a selected job contractor.

15. The method of claim 13 wherein said step of enabling each employer to obtain an interpreted job performance further includes the step of:
providing the average weighted numerical levels solicited from all of said employers in said database for each of a plurality of job attributes for all of the job contractors in the database,
whereby an employer may compare said interpreted job performance of a selected job contractor to the average weighted levels for said job attributes for all of said job contractors.

16. The method of claim 14 wherein said step of enabling each employer to obtain an interpreted job performance further includes the step of:
displaying the numerical total of said combined job performance evaluations said interpreted job performance evaluation is based upon.

17. A computer program having code recorded on a computer readable medium for management of a display computer controlled database system for providing data relative to the job performances of short term job contractors comprising:
means for storing job performance evaluations for each of a plurality of short term job contractors;
means for soliciting said job performance evaluations from each of a plurality of employers for each of said plurality of job contractors;
means for interpreting said job performance evaluations for each of said job contractors; and
means enabling each of said employers to obtain an interpreted job performance evaluation for each of said job contractors.

18. The computer program of claim 17 wherein:
said means for interpreting said job performance evaluations combine the job performance evaluations from a plurality of said employers for each of said job contractors.

19. The computer program of claim 18 wherein said evaluations include weighted numerical evaluations.

20. The computer program of claim 19 wherein said combined evaluations include the average weighted numerical evaluations of said plurality of employers.

21. The computer program of claim 19 wherein said each of said combined evaluations include a plurality of weighted numerical levels solicited from said employers for each of a plurality of job attributes for a selected job contractor.

22. The computer program of claim 21 wherein said combined evaluations includes a plurality of average weighted numerical levels solicited from said plurality of employers for each of a plurality of job attributes for a selected job contractor.

23. The computer program of claim 22 wherein said means enabling each employer to obtain an interpreted job performance further includes:
means providing the average weighted numerical levels solicited from all of said employers in said database for each of a plurality of job attributes for all of the job contractors in the database,
whereby an employer may compare said interpreted job performance of a selected job contractor to the average weighted levels for said job attributes for all of said job contractors.

24. The computer program of claim 22 wherein said means enabling each employer to obtain an interpreted job performance further includes:
the numerical total of said combined job performance evaluations said interpreted job performance evaluation is based upon.
